(19) United States
(12) Patent Application Publication
(10) Pub. No.: US 2024/0172069 A1
(43) Pub. Date: May 23, 2024

(54) CELL RESELECTION METHOD AND USER EQUIPMENT

(71) Applicant: KYOCERA Corporation, Kyoto (JP)

(72) Inventors: Masato FUJISHIRO, Yokohama-shi (JP); Henry CHANG, San Diego, CA (US); Mitsutaka HATA, Yokohama-shi, Kanagawa (JP)

(73) Assignee: KYOCERA Corporation, Kyoto (JP)

(21) Appl. No.: 18/426,842

(22) Filed: Jan. 30, 2024

Related U.S. Application Data
(63) Continuation of application No. PCT/JP2022/029553, filed on Aug. 1, 2022.
(60) Provisional application No. 63/228,253, filed on Aug. 2, 2021.

(51) Int. Cl. H04W 36/00

(52) U.S. Cl. CPC H04W 36/0094; H04W 36/0007; H04W 36/0058

(57) ABSTRACT

In a first aspect, a cell reselection method is used in a user equipment in an RRC idle state or an RRC inactive state, the cell reselection method including: specifying a service or a function that the user equipment desires to use; selecting a target in response to an instruction from a network or periodically with, as a candidate, a cell or a frequency having a result of measurement processing, the result satisfying a predetermined condition, the measurement processing being performed on a cell or a frequency different from a current existing cell; and performing cell reselection to the target selected. The selecting of the target includes performing control for selecting, as the target, a cell or a frequency providing the service or the function specified.

### RELATED APPLICATIONS

The present application is a continuation based on PCT Application No. PCT/JP2022/029553, filed on Aug. 1, 2022, which claims the benefit of US Provisional Patent Application No. 63/228,253 filed on Aug. 2, 2021. The content of which is incorporated by reference herein in their entirety.

### TECHNICAL FIELD

The present disclosure relates to a cell reselection method and a user equipment used in a mobile communication system.

### BACKGROUND OF INVENTION

In the 3rd Generation Partnership Project (3GPP) standards, the technical specifications of New Radio (NR), which is a 5th generation (5G) radio access technology, are stipulated. The NR has features such as high speed, large capacity, high reliability, and low latency compared to Long Term Evolution (LTE), which is a 4th generation (4G) radio access technology. Various services and various functions are introduced into the NR (for example, see Non-Patent Document 1).

### CITATION LIST

### Non-Patent Literature

Non-Patent Document 1: 3GPP Technical Specification 3GPP TS 38.300 V16.6.0

### SUMMARY

In a first aspect, a cell reselection method is a cell reselection method used in a user equipment in an RRC idle state or an RRC inactive state, the cell reselection method including: specifying a service or a function that the user equipment desires to use; selecting a target in response to an instruction from a network or periodically with, as a candidate, a cell or a frequency having a result of measurement processing, the result satisfying a predetermined condition, the measurement processing being performed on a cell or a frequency different from a current existing cell; and performing cell reselection to the target selected. The selecting of the target includes performing control for selecting, as the target, a cell or a frequency providing the service or the function specified.

In a second aspect, a user equipment is a user equipment used in a mobile communication system, the user equipment including a controller that performs, when the user equipment is in an RRC idle state or an RRC inactive state: processing of specifying a service or a function that the user equipment desires to use; processing of selecting a target in response to an instruction from a network or periodically with, as a candidate, a cell or a frequency having a result of measurement processing, the result satisfying a predetermined condition, the measurement processing being performed on a cell or a frequency different from a current existing cell; and processing of performing cell reselection to the target selected. The controller performs, in the processing of selecting the target, control for selecting, as the target, a cell or a frequency providing the service or the function specified.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a base station (gNB) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a typical cell reselection procedure.

FIG. 7 is a diagram illustrating a typical random access procedure.

FIG. 8 is a diagram illustrating an example of an operation environment in a mobile communication system according to an embodiment.

FIG. 9 is a diagram illustrating an operation of a UE according to an embodiment.

FIG. 10 is a diagram illustrating a first example.

FIG. 11 is a diagram illustrating a second example.

FIG. 12 is a diagram illustrating a third example.

FIG. 13 is a diagram illustrating a fourth example.

FIG. 14 is a diagram illustrating a fifth example.

FIG. 15 is a diagram illustrating Option A of a supplementary note.

FIG. 16 is a diagram illustrating Option B of the supplementary note.

### DESCRIPTION OF EMBODIMENTS

In one cell, a large number of user equipments in a Radio Resource Control (RRC) idle state or an RRC inactive state may simultaneously start random access to use a specific service or function. Physical random access channel (PRACH) resources in one cell are limited. Thus, collision (contention) may occur when a plurality of user equipments perform random access using the same PRACH resource, and the random access may fail.

Thus, the present disclosure provides a cell reselection method and a user equipment for smoothing random access to use a desired service or function.

A mobile communication system according to an embodiment is described with reference to the drawings. In the description of the drawings, the same or similar parts are denoted by the same or similar reference signs.

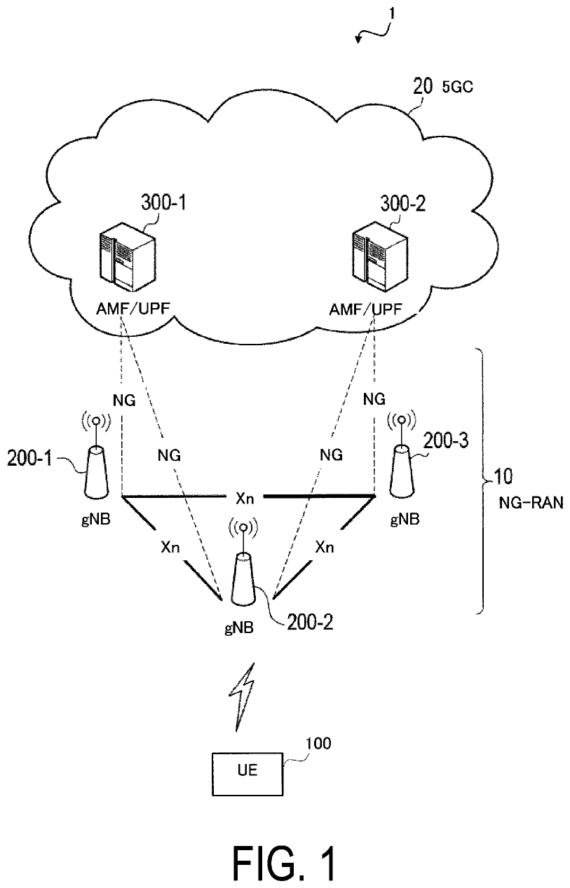

Configuration of Mobile Communication System FIG. 1 is a diagram illustrating a configuration of a mobile communication system according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. Hereinafter, the NG-RAN 10 may be simply referred to as a “RAN 10”. The 5GC 20 may be simply referred to as a core network (CN) 20.

The UE 100 is a mobile wireless communication apparatus. The UE 100 may be any apparatus as long as utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes base stations (referred to as “gNBs” in the 5G system) 200. The gNBs 200 are interconnected via an Xn interface, which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (also simply referred to as a “frequency” below).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface, which is an interface between a base station and the core network.

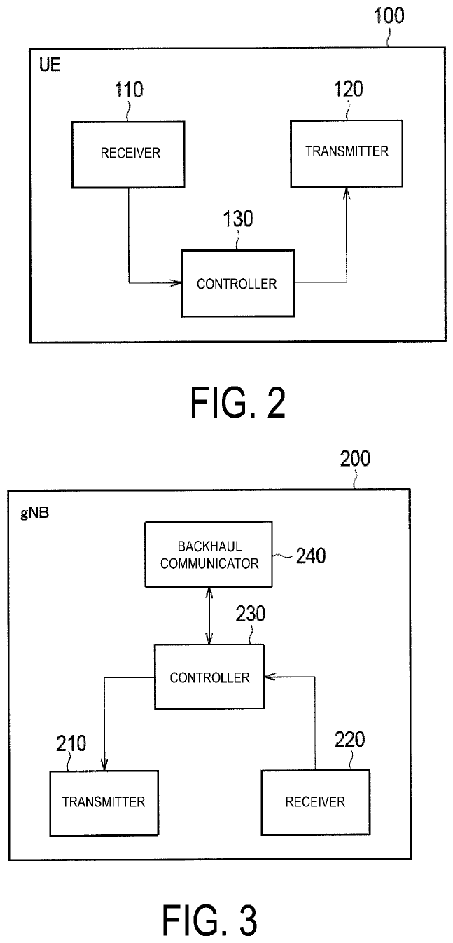

FIG. 2 is a diagram illustrating a configuration of the UE 100 (user equipment) to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the UE 100. Such processing includes processing of each layer described below. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

FIG. 3 is a diagram illustrating a configuration of the gNB 200 (base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of each layer described below. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the Xn interface, which is an inter-base station interface. The backhaul communicator 240 is connected to the AMF/UPF 300 via the NG interface, which is an interface between the base station and the core network. Note that the gNB 200 may include a Central Unit (CU) and a Distributed Unit (DU) (i.e., functions are divided), and the two units may be connected via an F1 interface, which is a fronthaul interface.

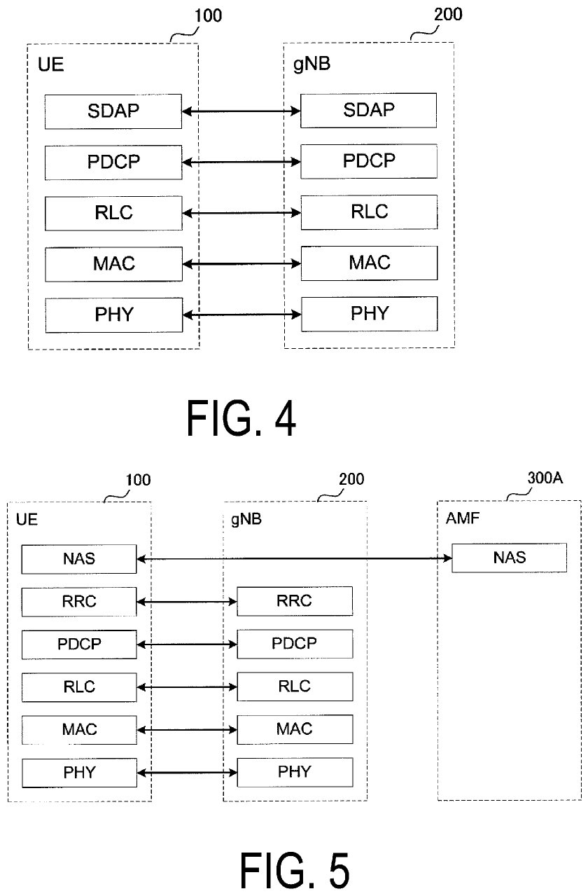

FIG. 4 is a diagram illustrating a configuration of a protocol stack of a radio interface of a user plane handling data.

The radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. The PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled using the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4. Note that each layer lower than the NAS layer is referred to as an AS layer.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of the AMF 300A. Note that the UE 100 includes an application layer other than the protocol of the radio interface.

Typical Cell Reselection

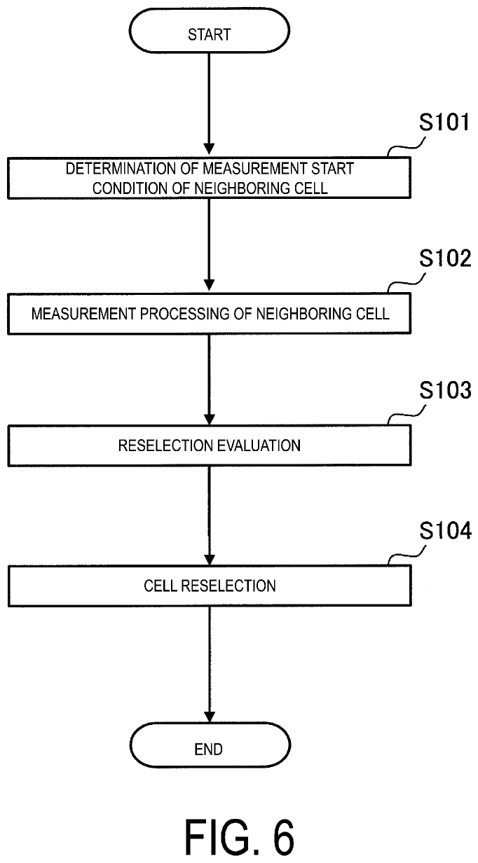

FIG. 6 is a diagram illustrating a typical cell reselection procedure. The UE 100 in the RRC idle state or the RRC inactive state performs cell reselection to move from a current existing cell to a neighboring cell. Note that in the cell reselection procedure, the priority of the cell reselection is considered. The priority is configured for each frequency, and the correspondence between the frequency and the priority is informed from the gNB 200 to the UE 100.

In Step S101, the UE 100 determines whether a measurement start condition is satisfied. The UE 100 measures the radio quality of a frequency with a priority higher than the priority of the frequency of the current existing cell all the time (Step S102). The radio quality may be reference signal received power and/or reference signal received quality. When the radio quality of the current existing cell is lower than a predetermined quality, the UE 100 measures the radio quality of a frequency with a priority equal to or lower than the priority of the frequency of the current existing cell (Step S102).

In Step S103, the UE 100 performs reselection evaluation based on the measurement result in Step S102. The UE 100 performs cell reselection to the neighboring cell when the priority of the frequency of the neighboring cell is higher than the priority of the current existing cell and the neighboring cell satisfies a predetermined quality standard for a predetermined period of time (Step S104). When the priority of the frequency of the neighboring cell is the same as the priority of the current existing cell, the UE 100 gives rank to the radio quality of the neighboring cell and performs cell reselection to the neighboring cell with a rank higher than the rank of the current existing cell for a predetermined period of time (Step S104). When the priority of the frequency of the neighboring cell is lower than the priority of the current existing cell, the radio quality of the current existing cell is lower than a certain threshold value, and the radio quality of the neighboring cell is continuously higher than another threshold value for a predetermined period of time, the UE 100 performs cell reselection to the neighboring cell (Step S104).

Typical Random Access

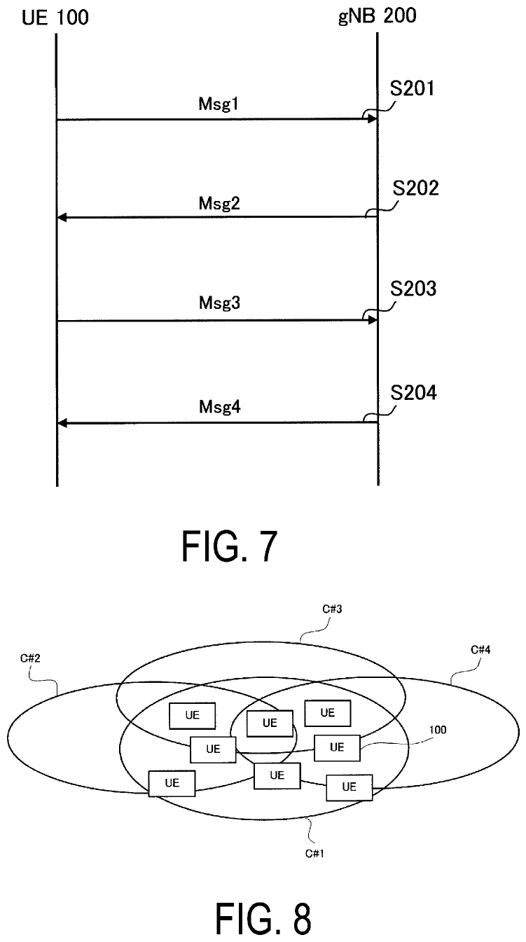

FIG. 7 is a diagram illustrating a typical random access procedure. The UE 100 starts a contention-based random access procedure in the current existing cell to transition from the RRC idle state or the RRC inactive state to the RRC connected state, for example.

In Step S201, the UE 100 transmits a random access preamble to the gNB 200 through a PRACH (Msg1). Here, the UE 100 randomly selects a PRACH resource from a PRACH resource set (PRACH parameters) informed by the gNB 200 using a system information block (SIB) and transmits the selected random access preamble. The PRACH resource includes a preamble sequence and a time-frequency resource of the random access preamble. A plurality of UEs 100 may select the same PRACH resource, and thus collision (contention) may occur.

In Step S202, the gNB 200 transmits a random access response to the UE 100 (Msg2). The gNB 200 includes information indicating the random access preamble received using Msg1 in the random access response. The gNB 200 gives the UE 100 an uplink grant for transmission of Msg3.

In Step S203, the UE 100 transmits an RRC message to the gNB 200 (Msg3). Here, when the random access response includes the information indicating the random access preamble transmitted by the UE 100, the UE 100 transmits the RRC message to the gNB 200 using an uplink shared channel (UL-SCH) resource allocated by the uplink grant. At the time of the above-described transmission of Msg1, when the plurality of UEs 100 select the same PRACH resource, the plurality of UEs 100 transmit Msg3 in response to one random access response. Note that the message (Msg3) transmitted by each UE 100 includes an information element unique to the UE 100.

In Step S204, the gNB 200 transmits, to the UE 100, identification data for contention resolution (Msg4). The gNB 200 may receive the plurality of messages (Msg3) from the plurality of UEs 100 in response to the one random access response. The gNB 200 returns one of the messages received as Msg3 as the identification data for contention resolution. When the message that has been transmitted as Msg3 by the UE 100 is returned from the gNB 200 as Msg4, the UE 100 considers that the random access has succeeded. On the other hand, when the message that has been transmitted as Msg3 by the UE 100 is not returned from the gNB 200 as Msg4, the UE 100 considers that the random access has failed and performs processing again from Step S201.

Operation of Mobile Communication System FIG. 8 is a diagram illustrating an example of an operation environment in the mobile communication system 1 according to the embodiment.

Each of the cells C #1 to C #4 is operated at a different frequency and geographically overlaps with other cells at least partially. The cells C #1 to C #4 may be managed by different gNBs 200 or may be managed by the same gNB 200.

A plurality of UEs 100 are in the RRC idle state or RRC inactive state and exist in the cell C #1. That is, the cell C #1 is an existing cell of the plurality of UEs 100. Each of the plurality of UEs 100 monitors paging (calling) from the cell C #1 in a paging occasion (PO) of a configured paging frame (PF).

In order to solve the problem that a large number of UEs 100 may be concentrated in one cell (or one frequency) in this manner, a redistribution procedure for allowing the UEs 100 to perform cell reselection under management of the network is introduced in 4G/LTE (see, for example, 3GPP TS36.304 and TS36.331). According to such a redistribution procedure, the large number of UEs 100 concentrated in the one cell (or one frequency) can be redistributed to other cells (or other frequencies).

The redistribution procedure may include two schemes of a Continuous Redistribution Scheme (CRS) and a One Shot Scheme (OSS). The CRS is a scheme of periodically triggering the redistribution procedure using a timer. The OSS is a scheme of triggering the redistribution procedure by including a redistribution instruction in a paging message from the gNB 200. An SIB from the gNB 200 includes a redistribution parameter used for the redistribution procedure. The UE 100 performs measurement processing on a neighboring cell and frequency and selects a target for cell reselection based on the redistribution parameter and the unique identifier of the UE 100.

Here, a large number of UEs 100 may simultaneously start random access in one cell in order to use a specific service or function. Since PRACH resources prepared in the one cell are limited, collision (i.e., PRACH collision) may occur due to random access performed by the plurality of UEs 100 using the same PRACH resource, and random access may fail.

To solve such a problem, it is conceivable to introduce the redistribution procedure into 5G/NR and distribute the plurality of UEs 100 to a plurality of cells (or a plurality of frequencies). However, different cells (or frequencies) may provide different services or functions. For example, a cell may provide a certain service, and a neighboring cell adjacent to the cell may not provide the service. Thus, when the redistribution procedure is introduced into 5G/NR, it is necessary to consider whether a cell (or frequency) that is a candidate of the cell reselection provides a service or function that the UE 100 desires to use.

In the following description, a “cell or frequency” is referred to as a “cell/frequency”, a cell/frequency that is a candidate of the cell reselection in the redistribution procedure is referred to as a “redistribution candidate”, and a target cell/frequency for the cell reselection selected from the redistribution candidates is referred to as a “redistribution target”. A service and a function that the UE 100 desires to use are referred to as a “desired service” and a “desired function”, and a “desired service or desired function” is referred to as a “desired service/desired function”. The “desired service” may be referred to as a “service in which the UE is interested”. The “desired function” may also be referred to as a “function in which the UE is interested”.

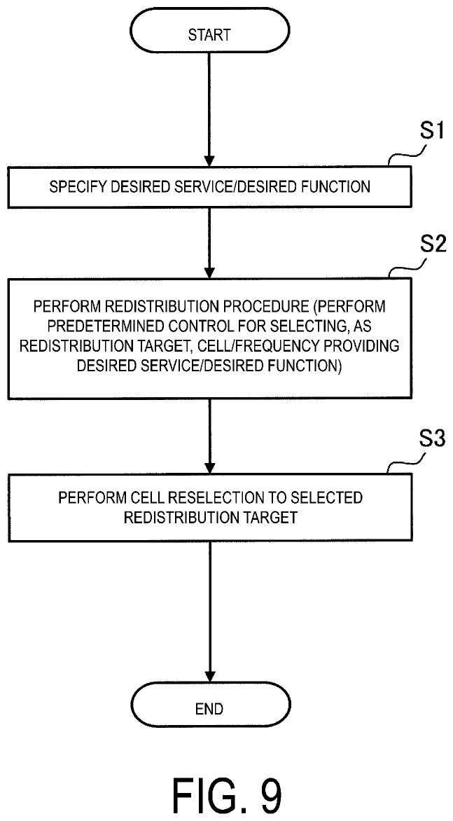

FIG. 9 is a diagram illustrating an operation of the UE 100 according to the embodiment. The UE 100 is assumed to be in the RRC idle state or the RRC inactive state.

In Step S1, the UE 100 specifies a desired service/desired function. For example, the UE 100 may specify the desired service by the application layer or the NAS layer determining the desired service. The UE 100 may specify the desired function based on the capability of the UE 100, communication status, or the like.

In Step S2, the UE 100 performs a redistribution procedure. Specifically, the UE 100 selects a redistribution target from the redistribution candidates in response to an instruction from the network (for example, an instruction by a paging message) or periodically (for example, each time a timer expires). Here, each redistribution candidate is a cell/frequency a result of measurement processing (inter-frequency measurement processing) of which satisfies a predetermined condition. The measurement processing is performed on a cell/frequency different from the current existing cell. The predetermined condition may be a condition that a predetermined quality standard is satisfied or a condition that the radio quality has the highest rank at a certain frequency.

In the redistribution procedure, the UE 100 performs control (hereinafter referred to as “predetermined control”) for selecting, as the redistribution target, a cell/frequency providing the desired service/desired function specified in Step S1. For example, the predetermined control may include first control of excluding a cell/frequency not providing the desired service/desired function from the inter-frequency measurement processing. The predetermined control may include second control of excluding the cell/frequency not providing the desired service/desired function from the redistribution candidate.

In Step S3, the UE 100 performs cell reselection to the redistribution target selected through the redistribution procedure. For example, the UE 100 sets the redistribution target selected through the redistribution procedure to have the highest priority as the priority of the cell reselection. As a result, the UE 100 performs the cell reselection to the redistribution target.

In this manner, the plurality of UEs 100 can be distributed to a plurality of cells/frequencies through the redistribution procedure, which can suppress PRACH collision. By introducing the control for selecting, as the redistribution target, the cell/frequency providing the desired service/desired function in the redistribution procedure, the cell reselection is not performed on the cell/frequency not providing the desired service/desired function. Thus, random access for using the desired service/desired function can be smoothed.

Step S1 may include a step of specifying, as the desired service, a multicast broadcast service that the UE 100 desires to use (hereinafter referred to as a “desired MBS”). Step S2 may include a step of performing predetermined control for selecting, as the redistribution target, a cell/frequency providing the desired MBS. This can smooth random access for using (receiving) the desired MBS.

Step S1 may include a step of specifying, as the desired service, a network slice that the UE 100 desires to use (hereinafter referred to as a “desired network slice”). Step S2 may include a step of performing predetermined control for selecting, as the redistribution target, a cell/frequency providing the desired network slice. This can smooth random access for using the desired network slice.

Step S1 may include a step of specifying, as the desired function, a function of handling a reduced-capability UE (hereinafter referred to as “RedCap UE”) having reduced communication capability. Such a function is referred to as a “RedCap function”. Step S2 may include a step of performing predetermined control for selecting, as the redistribution target, a cell/frequency supporting the RedCap function. This can smooth random access to the cell/frequency supporting the RedCap function as the desired function.

Step S1 may include a step of specifying, as the desired function, a function of handling uplink data transmission (hereinafter referred to as “Small Data Transmission (SDT)”) during the random access procedure. Such a function is referred to as an “SDT function”. Step S2 may include a step of performing predetermined control for selecting, as the redistribution target, a cell/frequency supporting the SDT function. This can smooth random access to the cell/frequency supporting the SDT function as the desired function.

Step S1 may include a step of specifying, as the desired function, a function for enhancing the coverage of the gNB 200 (hereinafter referred to as a “Coverage Enhancement (CE) function”). Step S2 may include a step of performing predetermined control for selecting, as the redistribution target, a cell/frequency supporting the CE function. This can smooth random access to the cell/frequency supporting the CE function as the desired function.

Step S2 may include a step of determining whether a detected cell detected by the inter-frequency measurement processing supports the desired function. The determining step may include a step of determining that the detected cell supports the desired function when the detected cell provides a PRACH resource associated with the desired function. Thus, the cell providing the desired function can be appropriately determined based on the premise that individual PRACH resources (PRACH resource set) are prepared for respective functions.

The UE 100 may determine that the detected cell supports the desired service when the detected cell provides the desired service. The desired service may be an MBS session. For the desired service, the detected cell may broadcast an MBS session identifier (session ID, Temporary Mobile Group Identity (TMGI), source specific IP address, or the like) using an SIB or MCCH. The MBS session identifier may be provided in advance as USD or the like from the network to the UE 100. The UE 100 may determine that the detected cell supports the desired MBS session when the MBS session identifier matches an identifier of an MBS session that the UE 100 is receiving or is interested in receiving.

Alternatively, the desired service may be a network slice. For the desired service, the detected cell may broadcast a network slice identifier (NSSAI, S-NSSAI, slice group ID, or the like). For the desired service, the detected cell may broadcast a slice-specific cell reselection parameter associated with the network slice. The UE 100 may determine that the detected cell supports the desired network slice when the network slice identifier matches an identifier of a slice intended (desired) to be used, which is provided from an upper layer.

### EXAMPLE

First to fifth examples will be described based on the configuration and operation described above. These examples can not only be separately and independently implemented, but can also be implemented in combination of two or more thereof. In an operation flowchart of each example described below, all steps may not be necessarily performed, and only some of the steps may be performed. In an operation flowchart of each example described below, the order of the steps may be changed.

### (1) First Example

The first example is an example in which the UE 100 in the RRC idle state or the RRC inactive state is receiving or is interested in receiving an MBS.

The MBS is a service in which the NG-RAN 10 can provide broadcast or multicast, i.e., Point To Multipoint (PTM) data transmission to the UE 100. Use cases (service types) of the MBS include public safety communication, mission critical communication, Vehicle to Everything (V2X) communication, IPv4 or IPv6 multicast delivery, Internet Protocol TeleVision (IPTV), group communication, and software delivery.

A broadcast provides a service to every UE 100 within a particular service area for an application not requiring highly reliable QoS. An MBS session used for the broadcast service is referred to as a broadcast session. A multicast provides a service not to every UE 100, but to a group of UEs 100 participating in a multicast service (multicast session). An MBS session used for the multicast service is referred to as a multicast session. The multicast service can provide the same content to the group of UEs 100 through a method with higher radio efficiency than the broadcast service.

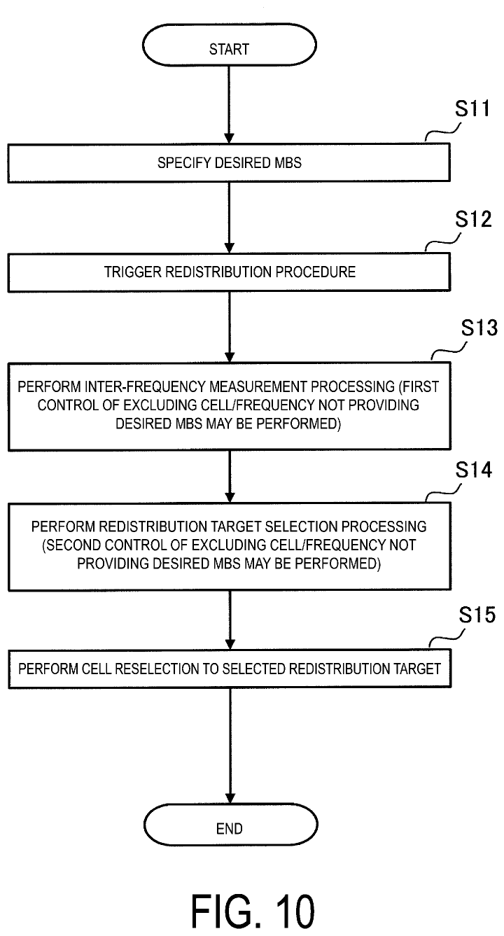

FIG. 10 is a diagram illustrating the first example.

In Step S11, the UE 100 specifies a desired MBS. For example, the UE 100 specifies an MBS session providing the desired MBS.

In Step S12, the UE 100 triggers a redistribution procedure.

In Step S13, the UE 100 performs inter-frequency measurement processing in the redistribution procedure. The UE 100 may limit measurement of a neighboring cell/frequency to a cell/frequency providing the desired MBS (desired MBS session) (first control). That is, the UE 100 may exclude a cell/frequency not providing the desired MBS (desired MBS session) from the inter-frequency measurement processing. Only a cell/frequency providing the desired MBS session in a PTM manner (particularly, in a broadcast manner) may be a target of the limitation (narrowing down of a cell/frequency).

Note that the UE 100 is assumed to acquire in advance which neighboring cell/frequency provides the desired MBS (which cell/frequency provides which MBS session) from the gNB 200 (current existing cell) using an SIB, RRC Release message, multicast control channel (MCCH) or the like. Alternatively, the UE 100 may acquire, as USD, information regarding which neighboring cell/frequency provides the desired MBS from the network in advance. The UE 100 may perform measurement of a neighboring cell/frequency once, acquire information regarding whether the neighboring cell provides the desired MBS based on an SIB or MCCH of the neighboring cell, and store the information in the memory.

In Step S14, the UE 100 performs redistribution target selection processing in the redistribution procedure. When making a list of a redistribution candidate based on the measurement result of the inter-frequency measurement in Step S13, the UE 100 may add only a cell/frequency providing the desired MBS (desired MBS session) to the list (second control). That is, the UE 100 may exclude a cell/frequency not providing the desired MBS (desired MBS session) from the redistribution candidate. Only a cell/frequency providing the desired MBS session in a PTM manner (particularly, in a broadcast manner) may be a target of the limitation (narrowing down of a cell/frequency). The UE 100 selects a redistribution target from the redistribution candidate list based on the redistribution parameter and the unique identifier of the UE 100.

In Step S15, the UE 100 performs cell reselection to the redistribution target selected in Step S14.

### (2) Second Example

The second example is an example in which the UE 100 in the RRC idle state or the RRC inactive state is interested in communication using a desired network slice. In the second example, redundant description of an operation same as, and/or similar to, that of the example described above will be omitted.

One or more networks (RAN 10 and CN 20) are logically divided into a plurality of slices in accordance with different service requirements and thus network slices are obtained. For example, each network slice is identified by a slice identifier such as Single-Network Slice Selection Assistance Information (S-NSSAI). Examples of the service type (SST) of the network slice include eMBB (high speed and large capacity), mMTC (many connections, power saving, and low cost), and URLLC (low latency and high reliability).

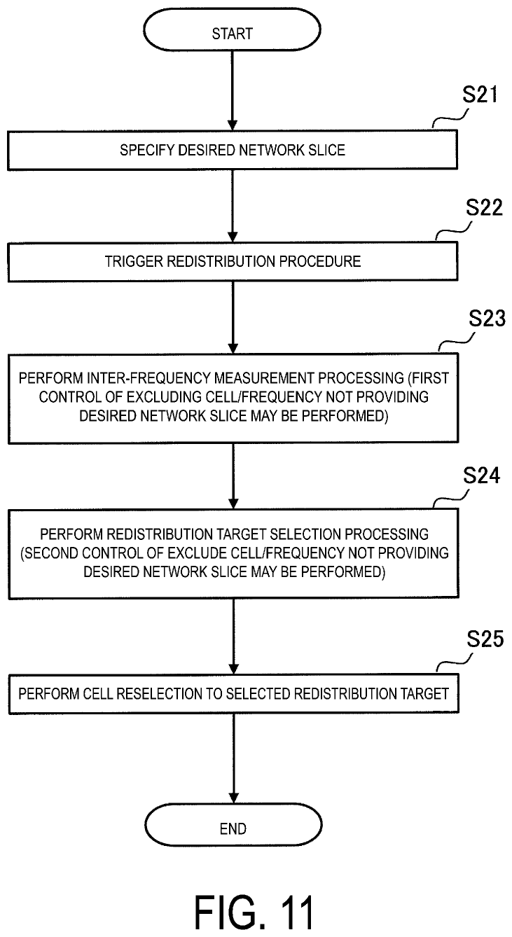

FIG. 11 is a diagram illustrating the second example.

In Step S21, the UE 100 specifies a desired network slice. For example, in the UE 100, the NAS layer may inform the AS layer of the desired network slice. The desired network slice may be a network slice group including a plurality of network slices.

In Step S22, the UE 100 triggers a redistribution procedure.

In Step S23, the UE 100 performs inter-frequency measurement processing in the redistribution procedure. The UE 100 may limit measurement of a neighboring cell/frequency to a cell/frequency providing the desired network slice (first control). That is, the UE 100 may exclude a cell/frequency not providing the desired network slice (desired slice identifier) from the inter-frequency measurement processing.

Note that the UE 100 is assumed to acquire in advance which neighboring cell/frequency provides which slice (slice identifier) from the gNB 200 (current existing cell) using an SIB, RRC Release message, MCCH, or the like. The UE 100 may acquire an SIB of a neighboring cell and determine whether the neighboring cell provides the desired network slice. For example, the UE 100 may determine that the neighboring cell provides the desired network slice when the neighboring cell provides a slice-specific cell reselection parameter associated with the desired network slice in the SIB, provides a slice-specific PRACH parameter associated with the desired network slice in the SIB, or informs an available slice identifier or slice group identifier (identifier of a group including one or more slices) in the SIB

In Step S24, the UE 100 performs redistribution target selection processing in the redistribution procedure. When making a list of a redistribution candidate based on the measurement result of the inter-frequency measurement in Step S23, the UE 100 may add only a cell/frequency providing the desired network slice to the list (second control). That is, the UE 100 may exclude a cell/frequency not providing the desired network slice (desired network slice identifier) from the redistribution candidate. The UE 100 selects a redistribution target from the redistribution candidate list based on the redistribution parameter and the unique identifier of the UE 100.

In Step S25, the UE 100 performs cell reselection to the redistribution target selected in Step S24.

### (3) Third Example

The third example is an example in which the UE 100 in the RRC idle state or the RRC inactive state is interested in communication using a RedCap function. In the third example, redundant description of an operation same as, and/or similar to, those of the examples described above will be omitted.

A RedCap UE, which is a UE with reduced communication capability compared to a typical UE 100, can be configured at low cost and can operate with low power consumption. The number of reception devices (Rx chains) included in the RedCap UE may be smaller than that in the typical UE 100. In Msg1 of a random access procedure, the RedCap UE performs PRACH transmission using a PRACH resource prepared for the RedCap UE. That is, the PRACH resource prepared for the RedCap UE is provided in distinction from another PRACH resource. The gNB 200 can transmit Msg2 appropriate for the RedCap UE by identifying the RedCap UE in Msg1. When such PRACH partitioning is applied, there may be less PRACH resources prepared for the RedCap UE, thus increasing the possibility of PRACH collision.

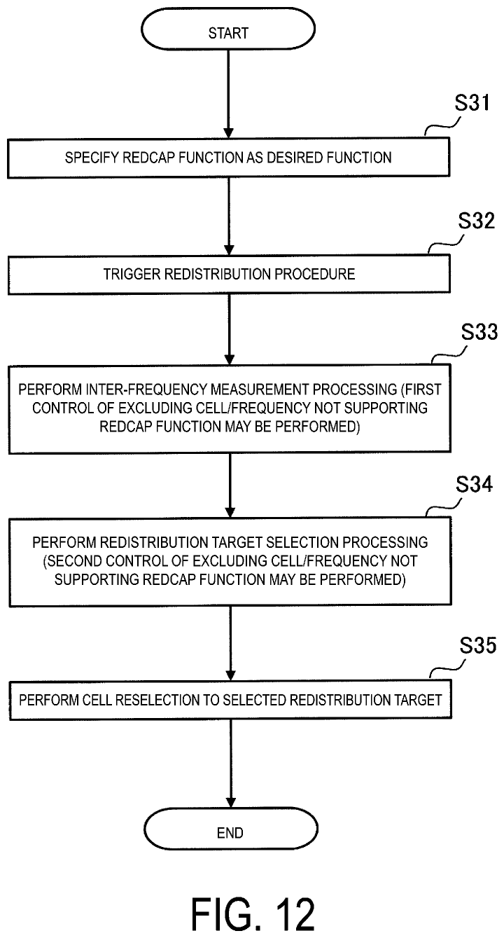

FIG. 12 is a diagram illustrating the third example.

In Step S31, the UE 100 specifies the RedCap function as a desired function. For example, the UE 100 specifies the RedCap function as the desired function when the UE 100 is a RedCap UE.

In Step S32, the UE 100 triggers a redistribution procedure.

In Step S33, the UE 100 performs inter-frequency measurement processing in the redistribution procedure. The UE 100 may limit measurement of a neighboring cell/frequency to a cell/frequency supporting the RedCap function (first control). That is, the UE 100 may exclude a cell/frequency not supporting the RedCap function from the inter-frequency measurement processing.

Note that the UE 100 is assumed to acquire in advance which neighboring cell/frequency supports the RedCap function from the gNB 200 (current existing cell) using an SIB, RRC Release message, MCCH, or the like. The UE 100 may acquire an SIB of a neighboring cell and determine whether the neighboring cell supports the RedCap function. For example, the UE 100 may determine that the neighboring cell supports the RedCap function when the neighboring cell provides a parameter associated with the RedCap function (such as a PRACH resource prepared for the RedCap UE or support information of the RedCap function) in the SIB.

In Step S34, the UE 100 performs redistribution target selection processing in the redistribution procedure. When making a list of a redistribution candidate based on the measurement result of the inter-frequency measurement in Step S33, the UE 100 may add only a cell/frequency supporting the RedCap function to the list (second control). That is, the UE 100 may exclude a cell/frequency not supporting the RedCap function from the redistribution candidate. The UE 100 selects a redistribution target from the redistribution candidate list based on the redistribution parameter and the unique identifier of the UE 100.

In Step S35, the UE 100 performs cell reselection to the redistribution target selected in Step S34.

### (4) Fourth Example

The fourth example is an example in which the UE 100 in the RRC idle state or the RRC inactive state is interested in communication using an SDT function. In the fourth example, redundant description of an operation same as, and/or similar to, those of the examples described above will be omitted.

The SDT is to transmit uplink data from the UE 100 to the gNB 200 in Msg3 in the random access procedure. When the SDT is used, the UE 100 performs PRACH transmission using a PRACH resource prepared for the SDT in Msg1 of the random access procedure. That is, the PRACH resource prepared for the SDT is provided in distinction from another PRACH resource. By identifying the SDT in Msg1, the gNB 200 can provide the UE 100 with an appropriate uplink grant in Msg2, for example an uplink grant corresponding to an RRC Resume Request message and the sum of uplink data. When such PRACH partitioning is applied, there may be less PRACH resources prepared for the SDT, thus increasing the possibility of PRACH collision.

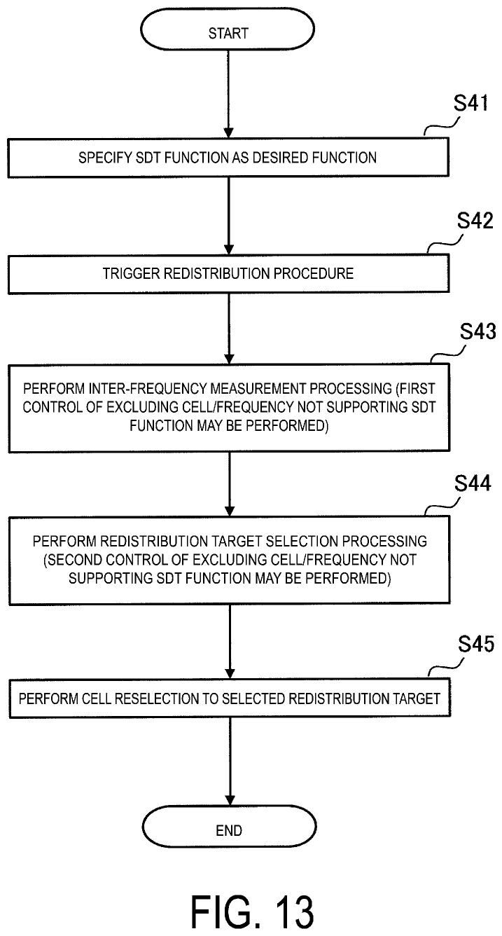

FIG. 13 is a diagram illustrating the fourth example.

In Step S41, the UE 100 specifies the SDT function as a desired function.

In Step S42, the UE 100 triggers a redistribution procedure.

In Step S43, the UE 100 performs inter-frequency measurement processing in the redistribution procedure. The UE 100 may limit measurement of a neighboring cell/frequency to a cell/frequency supporting the SDT function (first control). That is, the UE 100 may exclude a cell/frequency not supporting the SDT function from the inter-frequency measurement processing.

Note that the UE 100 is assumed to acquire in advance which neighboring cell/frequency supports the SDT function from the gNB 200 (current existing cell) using an SIB, RRC Release message, or the like. The UE 100 may acquire an SIB of a neighboring cell and determine whether the neighboring cell supports the SDT function. For example, the UE 100 may determine that the neighboring cell supports the SDT function when the neighboring cell provides a parameter associated with the SDT function (such as a PRACH resource prepared for the SDT or support information of the SDT function) in the SIB.

In Step S44, the UE 100 performs redistribution target selection processing in the redistribution procedure. When making a list of a redistribution candidate based on the measurement result of the inter-frequency measurement in Step S43, the UE 100 may add only a cell/frequency supporting the SDT function to the list (second control). That is, the UE 100 may exclude a cell/frequency not supporting the SDT function from the redistribution candidate. The UE 100 selects a redistribution target from the redistribution candidate list based on the redistribution parameter and the unique identifier of the UE 100.

In Step S45, the UE 100 performs cell reselection to the redistribution target selected in Step S44.

### (5) Fifth Example

The fifth example is an example in which the UE 100 in the RRC idle state or the RRC inactive state is interested in communication using a CE function. In the fifth example, redundant description of an operation same as, and/or similar to, those of the examples described above will be omitted.

The CE is to enhance the coverage of the gNB 200 by repeated signal transmission or the like. When the CE is used, the UE 100 performs PRACH transmission using a PRACH resource prepared for the CE (specifically, PRACH resource prepared for each CE level) in Msg1 of the random access procedure. The CE level is a level associated with the number of times of repeated transmission. That is, the PRACH resource prepared for the CE is provided in distinction from another PRACH resource. By identifying the CE level of the UE 100 in Msg1, the gNB 200 can transmit Msg2 at the number of times of repeated transmission corresponding to the CE level. When such PRACH partitioning is applied, there may be less PRACH resources prepared for the CE, thus increasing the possibility of PRACH collision.

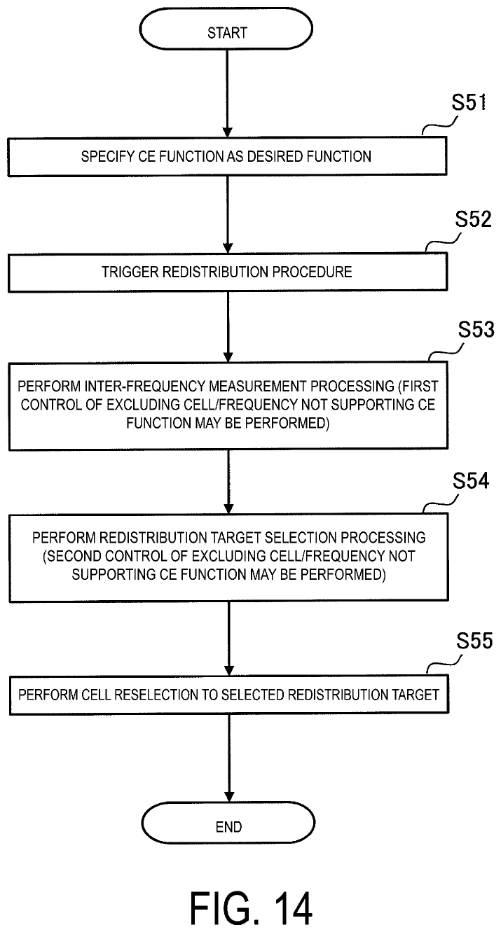

FIG. 14 is a diagram illustrating the fifth example.

In Step S51, the UE 100 specifies the CE function as a desired function.

In Step S52, the UE 100 triggers a redistribution procedure.

In Step S53, the UE 100 performs inter-frequency measurement processing in the redistribution procedure. The UE 100 may limit measurement of a neighboring cell/frequency to a cell/frequency supporting the CE function (first control). That is, the UE 100 may exclude a cell/frequency not supporting the CE function from the inter-frequency measurement processing.

Note that the UE 100 is assumed to acquire in advance which neighboring cell/frequency supports the CE function from the gNB 200 (current existing cell) using an SIB, RRC Release message, MCCH, or the like. The UE 100 may acquire an SIB of a neighboring cell and determine whether the neighboring cell supports the CE function. For example, the UE 100 may determine that the neighboring cell supports the CE function when the neighboring cell provides a parameter associated with the CE function (such as a PRACH resource prepared for the CE or support information of the CE function) in the SIB.

In Step S54, the UE 100 performs redistribution target selection processing in the redistribution procedure. When making a list of a redistribution candidate based on the measurement result of the inter-frequency measurement in Step S53, the UE 100 may add only a cell/frequency supporting the CE function to the list (second control). That is, the UE 100 may exclude a cell/frequency not supporting the CE function from the redistribution candidate. The UE 100 selects a redistribution target from the redistribution candidate list based on the redistribution parameter and the unique identifier of the UE 100.

In Step S55, the UE 100 performs cell reselection to the redistribution target selected in Step S54.

### Other Embodiments

In the embodiment and examples described above, an example in which the base station is an NR base station (gNB) has been described; however, the base station may be an LTE base station (eNB) or a 6G base station. The base station may be a relay node such as an Integrated Access and Backhaul (IAB) node. The base station may be a DU of an IAB node. The user equipment may be a mobile termination (MT) of the IAB node.

The MT may perform an operation as illustrated in FIG. 9. In this case, the desired function may be an IAB function. That is, the MT may perform the redistribution procedure in Step S2 and also perform predetermined control for selecting, as the redistribution target, a cell/frequency supporting the IAB function as the desired function.

In the embodiment and examples described above, the 4-step (Msg1 to Msg4) random access procedure is assumed. However, a 2-step random access procedure may be assumed. In the 2-step random access procedure, the UE 100 collectively transmits Msg1 and Msg3 to the gNB 200 as MsgA, and the gNB 200 collectively transmits Msg2 and Msg4 to the UE 100 as MsgB. A PRACH resource prepared for the transmission of MsgA is used for the transmission of MsgA.

The desired function may be a function of handling the 2-step random access procedure. That is, the UE 100 or the MT may perform the redistribution procedure in Step S2 illustrated in FIG. 9 and also perform predetermined control for selecting, as the redistribution target, a cell/frequency supporting the 2-step random access procedure as the desired function.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing the processes to be performed by the UE 100 or the gNB 200 may be integrated, and at least part of the UE 100 or the gNB 200 may be configured as a semiconductor integrated circuit (a chipset or an SoC).

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

Supplementary Note

### Introduction

In RAN #88, revised work items have been approved that are related to NR multicast broadcast service (MBS). Group notification has been discussed in RAN2 #113bis-e and the following agreement has been reached.

Support Group Notification for Multicast for MBS Supporting Node

For Delivery mode 1, a UE is not expected to monitor an RRC-connected group notification channel.
Whether the RAN2 needs to handle a problem of PRACH capacity caused by the group notification needs to be further studied.
The same group notification ID is used in both of an RRC idle state and an RRC inactive state.

Reply LS

For a non-supporting node, use of an MBS session ID affects a non-MBS node and thus does not work. Unicast paging works.
The MBS session ID can be used to support the node.

### Short Post Mail Discussion for LS Reply.

In RAN2 #114-e, a paging message is used for the group notification.

A PCCH is used for multicast activation notification (also used for an MBS supporting node).

It is confirmed that the MBS session ID is conveyed by the notification.
Use of paging in all (legacy) POs using PRNTIs is a baseline assumption (other variants can still be discussed).

In this supplementary note, the details of the group notification and the problem of the PRACH capacity will be described.

Discussion

### Group Notification in Delivery Mode 1

### Confirmation of Baseline Assumption

The RAN2 has agreed that “a PCCH is used for multicast activation notification (also used for an MBS supporting node)” and “use of paging in all (legacy) POs using PRNTIs is a baseline assumption (other variants can still be discussed)”. These can be interpreted to mean that the legacy paging needs to be enhanced for the group notification. Thereby, the enhancement is intended to achieve a concept same as, and/or similar to, the concept of ETWS/CMAS notification in LTE. These agreements are beneficial for power consumption from the viewpoint of the UE and have little impact on paging resource load from the viewpoint of the NW.

Opinion 1: The baseline assumption made by the RAN2 is beneficial for power consumption of the UE and has only little impact on paging resource load.

In RAN2 #114-e, some companies who support a separate P-RNTI, separate PO, and/or separate paging message express concern particularly about potential impact increasing UE power consumption of a legacy UE. It seems necessary to analyze the impact of the RAN2 baseline (i.e., Opinion 1) on the legacy UE in comparison with an MBS service (i.e., PDU session) provided by unicast. This is because this method is merely a method up to Rel-16. In unicast, all UEs interested in an MBS service need to be paged by a legacy mechanism, i.e., one-by-one paging. These unicast paging messages are received by the legacy UEs, and additional power is consumed in proportion to the number of unicast paging transmissions of the UEs interested in the MBS service. Thus, even when the group notification is transmitted in all legacy POs in one paging DRX cycle using legacy P-RNTIs, an impact on the legacy UEs is substantially the same, and on the contrary, when many UEs are interested in the MBS service, the group notification is expected to be beneficial for power saving.

Opinion 2: Power consumption of the legacy UE is not problematic in the group notification.

It is pointed out that it is better to transmit the group notification only in the PO for the UE interested in the MBS service. It may be beneficial to reduce signal overhead when no UE misses the group notification, but it is assumed that such optimization can be handled by NW implementation.

Opinion 3: Optimization of use of the legacy PO depends on introduction of the NW.

Thus, the RAN2 needs to make sure that, at least from the viewpoint of the UE, the legacy P-RNTI and the legacy PO are reused and that the legacy paging message is enhanced for the group notification. The UE is only required to monitor the paging in the PO of the UE. That is, it means that this feature is the same as the legacy paging.

Proposal 1: The RAN2 is recommended to confirm the group notification using the legacy paging messages transmitted in all the legacy POs having the legacy P-RNTIs at least from the viewpoint of the UE.

Enhancement of Existing Paging Message

When Proposal 1 is agreed upon, it is necessary to discuss a method of integrating the group notification into the existing paging message. The current paging message includes a PagingRecordList, which is a list of paged UE-IDs, i.e., 5G-S-TMSIs or I-RNTIs. The following two options are conceivable for the group notification by the paging.

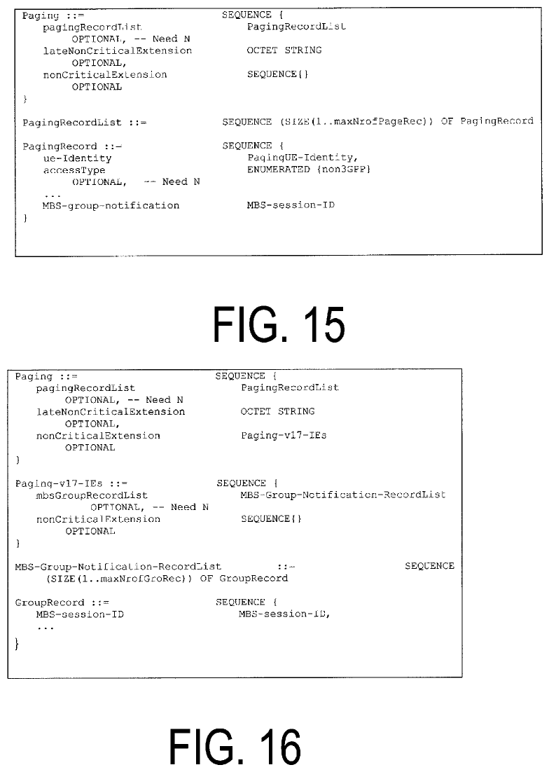

Option A: The MBS session ID is described in the existing PagingRecord list (an example is illustrated in FIG. 15).

Option B: The MBS session ID is indicated in a new list (an example is illustrated in FIG. 16).

Option A may be technically feasible as in the above example, but since the UE-ID cannot be deleted from the PagingRecord unless non-backward compatibility can be ignored, the UE-ID for unicast and the MBS session ID need to coexist in the same Record. It can be considered to add the MBS session ID to the PagingUE-ID. However, the MBS session ID is not the UE-ID and thus has a concept different from the 5G-S-TMSI and the I-RNTI, which thus seems to be slightly unnatural.

Option B can be implemented as in the above example and is simple. There is no contradiction with the concept of the existing IE. Because the enhanced concept of ETWS/CMAS notification in LTE is reused, there can be no impact on the legacy UE.

Thus, the RAN2 needs to agree to define a new list in the paging message, that is, Option B.

Proposal 2: The RAN2 is recommended to agree to define a new list for the group notification in the existing paging message.

Problem of PRACH Capacity

### Definition of Problem

Whether to handle the problem of the PRACH capacity needs to be further studied. Due to the group notification, many UEs are simultaneously paged and many PRACH collisions occur. Furthermore, the four WIs (RedCap, SDT, Coverage Enhancements, and RAN Slicing) of Rel-17 currently considers using PRACH partitioning to indicate original Message 1, which however may affect the overall PRACH capacity. Thus, in the Rel-17 network, regardless of the multicast service or the unicast service, the access latency may be increased due to an increase in PRACH collision.

Typically, the PRACH capacity is handled by appropriate NW implementation. For example, the gNB can prepare more resources before starting the multicast session. However, this may not apply in the case of Rel-17 according to some observations, in addition to the nature of the group notification and many Msg1 indications. On the other hand, it is pointed out that in NW implementation, the UE can be kept in the RRC connected state until the multicast session is started/activated or until the session is deactivated in order to avoid PRACH collision. Needless to say, since the UE in the RRC connected state transmits much more signals than the UE in the idle/inactive state, this is not preferable from the viewpoint of both power consumption of the UE and the resource efficiency of the NW. Thus, it takes large cost in this option only to avoid PRACH collision.

Opinion 4: The option of the NW implementation for keeping the UE in the RRC connected state only to avoid PRACH transmission from the UE is not preferable from the viewpoint of both power consumption of the UE and spectral efficiency.

In the group notification of Delivery mode 1, the capacity of the PRACH is considered to be certainly problematic. Thus, the RAN2 needs to discuss a method of solving this problem.

Proposal 3: the RAN2 is recommended to discuss a method of solving the problem of the PRACH capacity caused by the group notification, i.e., NW implementation or a standard mechanism of distributing PRACH transmissions.

Approach to Assumed Solution When the introduction of the standard mechanism of distributing PRACH transmissions from a plurality of UEs is proposed in Proposal 3, the following two approaches are conceivable.

Approach A: Frequency Domain Spreading

This method aims to distribute PRACH transmissions over a plurality of frequencies. In the same or a similar problem, Multicarrier Load Distribution (MCLD) actually discussed in Rel-13 LTE enables redistribution of idle UEs to a plurality of frequencies. Thus, there may be an option for the gNB to perform redistribution immediately before transmitting the group notification. A drawback of this approach is that when no other frequency provides an intended MBS service through PTM, the UE either provides the MBS service by unicast or performs handover to a frequency providing the PTM.

Approach B: Time Domain Spreading

This method aims to distribute PRACH transmissions over a plurality of timings. A certain transmission occasion in which a PRACH is allowed in a set of UEs and is not allowed in another set of UEs is considered to be needed. A drawback of this method is that since a new mechanism is required, more standard approaches such as a method of grouping UEs and a method of specifying a PRACH transmission occasion are required and that since some UEs need to wait for PRACH transmission for a certain period of time after receiving the group notification, access delay occurs.

These approaches have advantages and disadvantages as briefly described above. Thus, the RAN2 needs to discuss which approach is desirable, if necessary, in light of the actual deployment scenario of the NR MBS.

Proposal 4: According to the conclusions of Proposal 3, the RAN2 needs to further discuss whether to enhance PRACH transmissions from a plurality of UEs in a frequency domain and/or a time domain

### REFERENCE SIGNS

1: Mobile communication system
10: RAN
20: CN
100: UE
110: Receiver
120: Transmitter
130: Controller
200: gNB
210: Transmitter
220: Receiver
230: Controller
240: Backhaul communicator

1. A cell reselection method used in a user equipment in an RRC idle state or an RRC inactive state, the cell reselection method comprising:
specifying a service or a function that the user equipment desires to use;
selecting a target in response to an instruction from a network or periodically with, as a candidate, a cell or a frequency having a result of measurement processing, the result satisfying a predetermined condition, the measurement processing being performed on a cell or a frequency different from a current existing cell; and
performing cell reselection to the target selected, wherein
the selecting of the target comprises performing control for selecting, as the target, a cell or a frequency configured to provide the service or the function specified.

2. The cell reselection method according to claim 1, wherein the control comprises first control of excluding, from the measurement processing, a cell or a frequency configured not to provide the service or the function specified.

3. The cell reselection method according to claim 1, wherein the control comprises second control of excluding, from the candidate, a cell or a frequency configured not to provide the service or the function specified.

4. The cell reselection method according to claim 1, wherein
the specifying comprises specifying, as the service, a multicast broadcast service that the user equipment desires to use, and
the performing of the control comprises performing the control for selecting, as the target, a cell or a frequency configured to provide the multicast broadcast service specified.

5. The cell reselection method according to claim 1, wherein
the specifying comprises specifying, as the service that the user equipment desires to use, a network slice that the user equipment desires to use, and
the performing of the control comprises performing the control for selecting, as the target, a cell or a frequency configured to provide the network slice specified.

6. The cell reselection method according to claim 1, wherein
the specifying comprises specifying, as the function that the user equipment desires to use, a first function configured to handle a reduced-capability user equipment having a reduced communication capability, and
the performing of the control comprises performing the control for selecting, as the target, a cell or a frequency configured to support the first function.

7. The cell reselection method according to claim 1, wherein
the specifying comprises specifying, as the function that the user equipment desires to use, a second function configured to handle uplink data transmission during a random access procedure, and
the performing of the control comprises performing the control for selecting, as the target, a cell or a frequency configured to support the second function.

8. The cell reselection method according to claim 1, wherein
the specifying comprises specifying, as the function that the user equipment desires to use, a third function configured to enhance coverage of a base station, and
the performing of the control comprises performing the control for selecting, as the target, a cell or a frequency configured to support the third function.

9. The cell reselection method according to claim 1, wherein
the performing of the control comprises determining whether a detected cell detected through the measurement processing supports a desired function that the user equipment desires to use, and
the determining comprises determining that the detected cell supports the desired function when the detected cell provides a physical random access channel resource associated with the desired function.

10. A user equipment used in a mobile communication system, the user equipment comprising:
a controller configured to perform, when the user equipment is in an RRC idle state or an RRC inactive state:
processing of specifying a service or a function that the user equipment desires to use;
processing of selecting a target in response to an instruction from a network or periodically with, as a candidate, a cell or a frequency having a result of measurement processing, the result satisfying a predetermined condition, the measurement processing being performed on a cell or a frequency different from a current existing cell; and
processing of performing cell reselection to the target selected, wherein
the controller performs, in the processing of selecting the target, control for selecting, as the target, a cell or a frequency configured to provide the service or the function specified.
